(19) United States
(12) Patent Application Publication
(10) Pub. No.: US 2015/0328521 A1
(43) Pub. Date: Nov. 19, 2015

(54) Multi-Function Striking Bag and Mount

(71) Applicant: Bobby I Khunkhun, Calgary (CA)

(72) Inventor: Bobby I Khunkhun, Calgary (CA)

(21) Appl. No.: 14/713,441

(22) Filed: May 15, 2015

Related U.S. Application Data
(60) Provisional application No. 61/994,452, filed on May 16, 2014.

(51) Int. Cl. A63B 69/20; F16M 13/02

(52) U.S. Cl. CPC A63B 69/201; F16M 13/02; A63B 2244/102; A63B 2244/104; A63B 2244/106

(57) ABSTRACT

A striking bag features a flexible tube of resilient foam material, and a striking surface that is connected to an end of the flexible tube. An upper half of the striking surface increases in size moving away therefrom to a second spherically shaped half of the striking surface. A cover encases the flexible tube and striking surface together, and a threaded rod projects from an upper end of the flexible tube for coupling with a surface mount that is fastened to a ceiling or other suitable overhead surface. The surface mount features a metal plate into which the threaded rod is threaded, and a foam piece on the side of the plate that faces toward the support surface.

### CROSS-REFERENCE TO RELATED APPLICATIONS

This application claims benefit under 35 U.S.C. 119(e) of U.S. provisional application Ser. No. 61/994,452, filed May 16, 2015, the entirety of which is incorporated herein by reference.

### FIELD OF THE INVENTION

The present invention relates generally to striking bags, and more specifically to a striking bag with a shaped striking surface carried at the bottom end of a hollow flexible tube that is mounted to a ceiling beam or other suitable overhead support.

### BACKGROUND

In the fields of boxing and martial arts, it is well known to use a striking bag for various training exercises. However, conventional striking bags are known to have some potential drawbacks, including notable vibration and noise levels when struck/used, and mounting solutions that create complications in installation and relocating a previously installed striking bag to another location.

Accordingly, there remains room for improvement in the field.

### SUMMARY OF THE INVENTION

According to one aspect of the invention there is provided an apparatus comprising:

a striking bag comprising:
a flexible tube; and
a striking surface that is connected to an end of the flexible tube and defines a widest portion of the striking bag.

According to another aspect of the invention there is provided an apparatus comprising:

a striking bag comprising:
a resiliently flexible tube extending in an axial direction defined by a central axis of the flexible tube, the flexible tube having a resiliency tending to bias the flexible tube into a straight position extending linearly along the central axis; and
a striking surface that is connected to an end of the flexible tube and has a greater diameter than the flexible tube.

In one embodiment, the striking surface comprises a tapered portion that increases in diameter moving away from the end of the flexible tube in the axial direction, and a rounded portion continuing in the axial direction from the tapered portion and terminating at a rounded end opposite thereto.

Preferably there is provided a mount having a threaded hole therein, wherein the striking bag comprises a threaded rod extending from a second opposing end of the flexible tube for releasable threaded coupling to the mount at the threaded hole therein.

Preferably the threaded rod reaches into a hollow opening of the flexible tube.

Preferably, the mount comprises a plate and a foam piece disposed on a side of said plate that faces toward a support surface in an installed position of the mount.

In one embodiment, the foam piece is disposed between the plate and a second plate that resides against the support surface in the installed position.

Preferably the striking bag further comprises a washer connected to the threaded rod at the second opposing end of the flexible tube.

Preferably there is provided a cover in which the flexible tube and the striking surface are encased together.

Preferably there is provided a hole in the cover through which the threaded rod extends from the flexible tube.

Preferably the flexible tube comprises a foam material.

### BRIEF DESCRIPTION OF THE DRAWINGS

Preferred embodiments of the invention will now be described in conjunction with the accompanying drawings in which:

FIG. 1 is a front elevation view of a striking bag and associated mount according to the present invention, showing the range of movement and motion of the striking bag.

FIG. 2 is a front elevation view of a first embodiment of the striking bag in its normal, static position when not in use.

FIG. 3 is an overhead plan view of the first embodiment striking bag of FIG. 2.

FIG. 4 is a front elevation view of a second embodiment of the striking bag in its normal, static position when not in use.

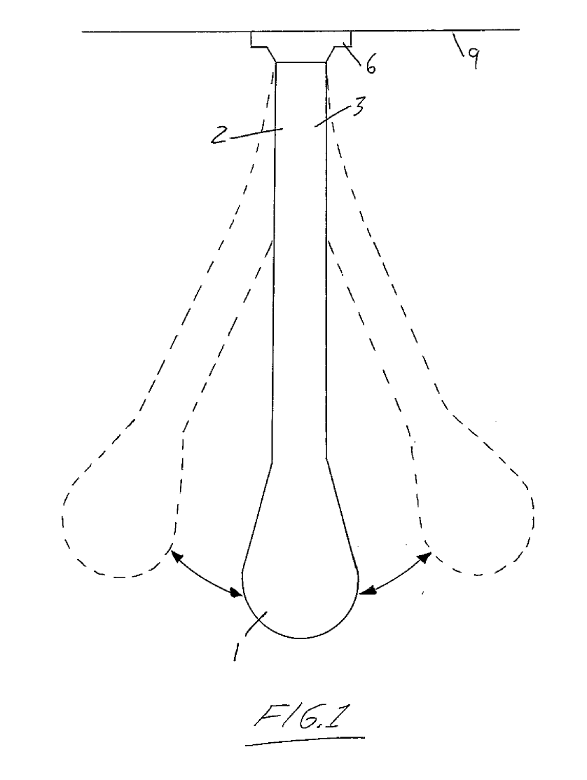

In the drawings like characters of reference indicate corresponding parts in the different figures.

### DETAILED DESCRIPTION

The drawings illustrate a novel striking bag according to one embodiment of the present invention. The top ¾ (approximately) of the striking bag is a long, hollow cylindrical tube 2 made from resiliently flexible foam. A central axis of the cylinder defines an axial direction of the striking bag, on which the cylindrical tube normally extends linearly in its default, relaxed state. A threaded rod 4 extends out from the top center hole of the cylindrical tube in the axial direction. An exposed end of the threaded rod 4 is situated externally of the flexible tube 2 beyond the upper end, and is screwed into a threaded lower opening of a surface mount 6. The mount is a disk like object that can be attached to an overhead support surface 9, such as a ceiling, by the use of screws 5. At the lowest point of the cylindrical tube, the striking bag begins to flare outwards and increases in size to a maximum diameter across the central axis, from which the bag then transitions to a hemispherical shape at the lowest point of the entire structure.

A striking surface 1 defines a widest and lowest portion of the striking bag. The bottom half of the striking surface 1 is hemispherical in shape. The top half of the striking surface 1 is elongated and tapers upwardly in size, in comparison to the bottom half. More specifically, in an upward direction along the central axis of the flexible tube 2, the tapered top half of the striking surface 1 decreases in diameter measured across the central axis. The smallest circumference of the striking surface 1 is at the top or the highest point of said striking surface 1, where it meets with the lower end of the flexible tube 2. The striking surface 1 has an overall tear-drop shape resulting from the combination of its tapered upper half and spherically contoured, for example hemispherically shaped, lower half. Material options for the body that defines the striking surface include foam, sponge, or an air bladder. It will be appreciated that the word “half” is being used herein not to necessarily denote two parts of equal proportion (whether in mass, volume, or other measure), but in the more general sense of two parts that combine to make a whole.

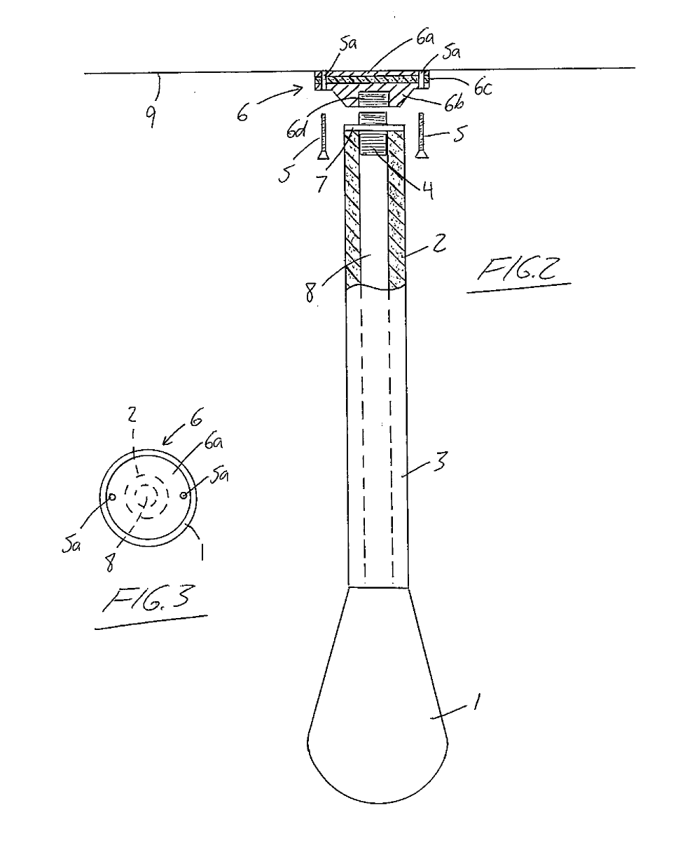

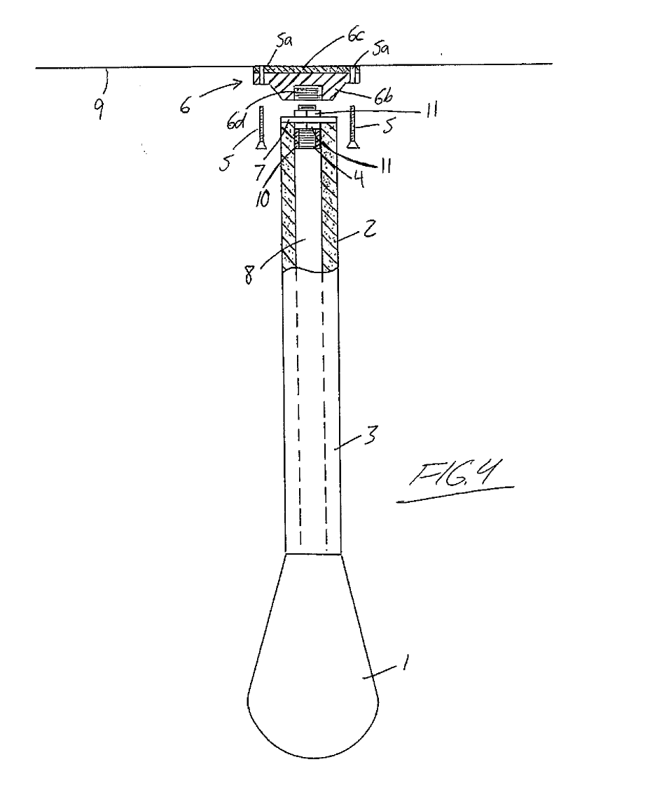

Upholstery 3 is a piece of fabric or other material used to form a singular cover that encases multiple parts of the striking bag, including the striking surface 1, the flex tube 2 and a washer 7. Some examples of materials that may be used are: vinyl, leather, nylon. The threaded rod 4 is inserted into the flex tube 2 and used to connect the flex tube 2 to the surface mount 6. Some examples of materials that may be used for the threaded rod 4 are: plastic, rubber, or metal. Screws 5 secure the surface mount 6 to the intended overhead, horizontal mounting surface, such as a ceiling. In one embodiment, shown in FIG. 2, the surface mount 6 features two metal plates or discs 6a, 6b that are stacked together on opposing sides of a disc-shaped piece of foam 6c received in a sandwiched position between the two plates. The top plate 6a abuts against the support surface 9. The surface mount 6 has a threaded hole 6d in the bottom plate which allows the threaded rod 4 to be connected to it. Screw holes run through the full mount (i.e. fully through the 2 metal plates and the foam disc therebetween) from north to south (i.e. top to bottom). The diameter of the inside hole of the washer 7 is slightly larger than the outside diameter of threaded rod, so that the threaded rod can pass through the washer. In another embodiment shown in FIG. 4, the mount features only a single plate 6b on the side of the foam piece 6c opposite the support surface 9.

The striking surface 1 and the flex tube 2 are connected by the upholstery 3, which encases both the striking surface 1 and the flex tube 2. In addition to the upholstery 3, the striking surface 1 and flex tube 2 can be connected to one another using glue, heat (foam to foam), a dowel, or a threaded rod. The upholstery 3 encases the striking surface 1, the flex tube 2, and the washer 7. The upholstery 3 has a hole that overlies that of the washer 7 to allow the threaded rod 4 to pass through the washer and the upholstery 3 at the top of the flex tube 2. The threaded rod 4 is inserted into the hollow opening of the flex tube 2 and extends outwards past the end of the flex tube 2. The threaded rod 4 may be secured to the flex tube 2 by glue, as is the case for the first embodiment of FIG. 2, or by gluing one or more foam sheets 10 to the threaded rod 4 in positions wrapped circumferentially therearound so that the now-padded rod fits snugly inside the flex tube, as shown in the second embodiment of FIG. 4, and then adding glue to the contact points between the flex tube 2 and the foam wrapped around the threaded rod 4. The screws 5 are inserted axially through the screw openings of the surface mount 6 and drilled into a support surface, such as a ceiling support beam. The screws 5 attach the surface mount 6 to the support surface. The threaded hole within the bottom plate of the surface mount 6 allows for the threaded rod 4 to be screwed into the surface mount 6 from below. The washer 7 is connected to the threaded rod. The washer 7 can be connected to the threaded rod by: manufacturing them together, using two nuts 11 to clamp the washer between the nuts 11 at an intermediate location along the threaded rod, or by creating a wider section on the threaded rod 4 where the washer 7 would rest Regardless of how it is secured to the rod, the washer creates an effective flange projecting radially outward from the threaded rod. The threaded rod 4 is inserted into the flex tube 2, until the washer 7 rests on the upper section of the flex tube 2. The washer 7, striking surface 1, and flex tube 2 are covered with upholstery 3, which secures the washer 7 to flex tube 2 by encasing them together within the singular piece of upholstery material.

The resulting striking bag is a striking device where the striking surface 1 is intended to be struck using various punching and elbow strikes. The striking surface 1 is connected to the flex tube 2. When the striking surface 1 is struck in a direction transverse to the central axis, the striking surface 1 will travel in the same direction of the strike. The impact of the strike travels into the flex tube 2 and causes a flex and/or bend throughout the flex tube 2. The resiliency of the material used for the flex tube 2 causes it to respond to any impact or movement by returning back into the direction of the strike and quickly returning back to its original and resting position.

The surface mount 6 anchors the striking bag to a support surface, such as a ceiling beam. The screws 5 are inserted into the surface mount screw holes 5s and screwed into the support surface. The screw holes of the surface mount pass axially through the entirety thereof at a radial distance outward from the threaded hole at the center of the mount. The entire screw travels through the surface mount 6, except for the screw head. The screw head of the screw 5 does not pass through the screw openings of the surface mount 6, and therefore it clamps or fastens the surface mount 6 to the support surface. Once the surface mount 6 is securely attached to the support surface the remainder of the striking bag can be attached to the surface mount 6. Unless the washer and threaded rod were previously combined, the threaded rod 4 is then inserted into the washer 7 and the washer 7 is attached to the threaded rod 4, connecting both items together. The threaded rod 4 is inserted into the hollow opening 8 of the flex tube 2 until the washer 7 is resting on the top of the flex tube 2, for example after wrapping foam sheets around the threaded rod 4 below the washer and putting glue inside the hole at the top of the flex tube. The threaded rod extends past the end of the flex tube, allowing the threaded rod to be screwed into the surface mount. The upholstery 3 is used to tightly secure items of the striking bag together. The striking surface 1, flex tube 2, and washer 7 are all securely encased in the upholstery 3. A hole in the upholstery 3 allows the threaded rod 4 to pass through the washer and upholstery. This hole in the upholstery 3 therefore allows the threaded rod 4 to be connected to the surface mount 6 while also being secured to the flex tube 2 connected via the threaded rod's connection to the washer 7 and the washer's secured state on the flex tube 2 due to the upholstery 3. When the threaded rod 4 is threaded into the mount 6, the annular area of the upholstery spanning over the washer 7 and around the threaded rod 4 at the top end of the flex tube 2 is clamped in place between the washer and the underside of the mount 4.

The striking bag has the ability to flex and bend when the striking surface 1 is struck or moved from the resting position. The farther the striking surface is moved from its resting position the more the flex tube 2 will flex and bend. The larger the flex in the flex tube 2 the greater the velocity is of the striking bag in return to its resting position. This movement allows for reflex, accuracy and timing training by striking the striking surface while it is in motion. This movement allows for defensive training because of the ability of the striking surface to travel into the direction of the striker.

The flex tube 2 is a one piece foam tube, for example an extruded foam tube, similar to a polyethylene extruded tube or foam pool noodle. The striking surface 1 can be made from molded foam, an air filled ball, cloth ball or an air bladder in the desired shape. The threaded rod 4 can be made from plastic, rubber or vinyl, for example. The threaded rod 4 has a width that tightly fits into the hole or bore that runs axially through the flex tube 2 when the threaded rod 4 is inserted into the flex tube 2, thereby providing a frictional grip between the external threads of the rod 4 and the surrounding flex tube 2. The washer 7 can be attached to the threaded rod 4 using two nuts 11 on the top and bottom of the washer 7 in the desired location on the threaded rod 4, as shown in FIG. 4. The washer 7 can also be attached to the threaded rod 4 by manufacturing both items together as seamlessly integral parts of a unitary piece, or by gluing them together, as shown in FIG. 2, or by creating a wider section on the threaded rod 4 where the washer 7 would rest. The flex tube 2, striking surface 1 and washer 7 are securely connected by encasing them in the upholstery 3. The upholstery 3 can be anchored directly to the washer 7, or to a separate member that rests on top of the washer 7, for example. The washer may be a standard metal washer, for example to which the upholstery is adhered, or may be made of other materials, such as plastic or wood, in which case the upholstery may be fastened to the washer by staples, for example. In one embodiment, the washer is a metal washer, and the separate member to which the upholstery is attached is a wooden washer to which the upholstery is stapled. In other embodiments, the washer may be omitted altogether, with the upholstery simply being sewn closed around the threaded rod. The upholstery 3 has a hole to allow the threaded 4 rod to travel through it. The surface 6 mount can be produced in metal, rubber or plastic. If metal is used the mount can be machined. If plastic or rubber is used the mount can be molded.

While the illustrated embodiments employ two initially separate pieces for the flex tube 2 and the striking surface 1, the flex tube and striking surface may be molded together as seamlessly integral parts of a single unitary piece using techniques such as direct injection molding.

In summary of the illustrated embodiments, a striking bag is removably mounted on a horizontal support surface, such as a ceiling. The lowest part of the bag has the largest surface area and is intended to be struck. The striking surface 1 and flex tube absorb and dissipate vibration and noise when struck. In the illustrated embodiment, foam is used throughout the striking bag, or at least for the hollow flexible tube from which the striking surface is suspended, and the foam's resiliency gives the striking bag the ability to return to its resting position quickly and with force when struck. The striking bag is attached directly to the mount and the mount attached to a support surface. The range of motion and flexibility provide a variety of training options. The inventive striking bag provides the functionality and training options of multiple striking bags on the market today, such as: speed bags, slip bags, double ended bags, and reflex bags. In at least some embodiments, the striking surface is softer than traditional punching bags. The striking bag may create less vibration and noise then traditional striking bags that are horizontally mounted. The striking bag can be quickly and easily removed from the mount simply by unthreading the rod 4 therefrom. The striking bag may be used to increase cardio, speed, reflexes and striking technique for anyone from expert martial artists to novices. The striking bag can be employed to train anyone on martial arts and boxing techniques using punches and elbows, for example to improve a user's accuracy, timing and reflexes in various martial arts and boxing strikes.

While the illustrated embodiment features a tapered striking surface that is generally tear-dropped in shape, other embodiments may employ striking surfaces of other shape, e.g. spherical or cylindrical, that likewise are greater in diameter than the flex tube from which they are suspended, and define the widest point of the overall striking bag.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. An apparatus comprising:
a striking bag comprising:
a flexible tube; and
a striking surface that is connected to an end of the flexible tube and defines a widest portion of the striking bag.

2. An apparatus comprising:
a striking bag comprising:
a resiliently flexible tube extending in an axial direction defined by a central axis of the flexible tube, the flexible tube having a resiliency tending to bias the flexible tube into a straight position extending linearly along the central axis; and
a striking surface that is connected to an end of the flexible tube and has a greater diameter than the flexible tube.

3. The apparatus of claim 2 wherein the striking surface comprises a tapered portion that increases in diameter moving away from the end of the flexible tube in the axial direction, and a rounded portion continuing in the axial direction from the tapered portion and terminating at a rounded end opposite thereto.

4. The apparatus of claim 2 further comprising a mount having a threaded hole therein, wherein the striking bag comprises a threaded rod extending from a second opposing end of the flexible tube for releasable threaded coupling to the mount at the threaded hole therein.

5. The apparatus of claim 4 wherein the threaded rod reaches into a hollow opening of the flexible tube.

6. The apparatus of claim 4 wherein the mount comprises a plate and a foam piece disposed on a side of said plate that faces toward a support surface in an installed position of the mount.

7. The apparatus of claim 6 wherein the piece of foam is disposed between the plate and a second plate that resides against the support surface in the installed position.

8. The apparatus of claim 4 wherein the striking bag further comprises a washer connected to the threaded rod at the second opposing end of the flexible tube.

9. The apparatus of claim 4 comprising a cover in which the flexible tube and the striking surface are encased together, the covering comprising a hole through which the threaded rod extends from the flexible tube.

10. The apparatus of claim 2 comprising a cover in which the flexible tube and the striking surface are encased together.

11. The apparatus of claim 2 further comprising a mount arranged for attachment to a support surface and for selecting coupling of the striking bag to the mount, wherein the mount comprises two plates and a foam piece therebetween.

12. The apparatus of claim 2 wherein the flexible tube comprises a foam material.
